(19) United States
(12) Patent Application Publication
(10) Pub. No.: US 2013/0184872 A1
(43) Pub. Date: Jul. 18, 2013

(54) ELECTRIC LOCK CONTROL CIRCUIT AND METHOD

(71) Applicants: WEI-YU CHEN, NEW TAIPEI CITY (TW); CHING-FENG HSIEH, TAIPEI CITY (TW)

(72) Inventors: WEI-YU CHEN, NEW TAIPEI CITY (TW); CHING-FENG HSIEH, TAIPEI CITY (TW)

(73) Assignees: ASKEY COMPUTER CORP.; ASKEY TECHNOLOGY (JIANGSU) LTD.

(21) Appl. No.: 13/435,024

(22) Filed: Mar. 30, 2012

(30) Foreign Application Priority Data
Jan. 13, 2012 (TW) 101101389

(51) Int. Cl. E05B 49/00; G05B 13/00

(52) U.S. Cl. 700/275; 70/278.1

(57) ABSTRACT

An electric lock control circuit and method allow users to control an electric lock with a reference password pertaining to a parameter related to at least two dimensions. The circuit includes a substrate, a memory unit, an input unit, and a processing unit. The memory unit stores the reference password. The input unit rotates in a space of at least two dimensions to generate a parameter signal related to at least two dimensions. The processing unit encodes the parameter signal to turn the parameter signal into an input code and outputs an unlocking signal or a locking signal based on a result of comparison of the input code and the reference password to control the electric lock. Controlling the electric lock with a reference password pertaining to a parameter related to at least two dimensions enhances confidentiality and complexity of the electric lock.

### CROSS-REFERENCE TO RELATED APPLICATION

This non-provisional application claims priority under 35 U.S.C. §119(a) on Patent Application No(s). 101101389 filed in Taiwan, R.O.C. on Jan. 13, 2012, the entire contents of which are hereby incorporated by reference.

### FIELD OF TECHNOLOGY

The present invention relates to electric lock control circuits and methods, and more particularly, to an electric lock control circuit and method for controlling an electric lock by a password pertaining to a parameter related to at least two dimensions.

### BACKGROUND

According to the prior art, safes are locked and unlocked with a mechanical dial for preventing unauthorized access to the safes.

However, the conventional mechanical dials of safes have at least one drawback. For example, unscrupulous person who understand the nuances in the structure of tenons and mortises of a conventional mechanical dial of a safe may guess the password of the conventional mechanical dial, using a stethoscope or their expertise. As a result, safes equipped with the conventional mechanical dials are not absolutely safe.

Accordingly, it is imperative to overcome the aforesaid drawback of the prior art.

### SUMMARY

It is an objective of the present invention to provide an electric lock control circuit whereby users lock and unlock an electric lock in a highly confidential and sophisticated manner.

Another objective of the present invention is to provide an electric lock control method whereby the electric lock features a high degree of confidentiality and is highly sophisticated, as the electric lock is controlled with a password pertaining to a parameter related to at least two dimensions.

In order to achieve the above and other objectives, the present invention provides an electric lock control circuit for controlling an electric lock with a reference password pertaining to a parameter related to at least two dimensions. The electric lock control circuit comprises a substrate, a memory unit, an input unit, and a processing unit. The memory unit is disposed on the substrate for storing the reference password. The input unit is disposed on the substrate for generating a parameter signal based on rotation of the input unit in a space of at least two dimensions. The processing unit is connected to the memory unit and the input unit for converting the parameter signal into an input code and sending a release lock signal to the electric lock when the input code matches the reference password.

In order to achieve the above and other objectives, the present invention provides an electric lock control method for controlling an electric lock having an input unit. The electric lock is controlled with a reference password pertaining to a parameter related to at least two dimensions. The method comprises step (a), step (b), and step (c). Step (a) involves rotating the input unit in a space of at least two dimensions to generate a parameter signal pertaining to a parameter related to at least two dimensions. Step (b) involves converting the parameter signal into an input code. Step (c) involves comparing the input code with the reference password when the electric lock is in a locked state to determine that a release lock signal has to be sent to the electric lock when a result of the comparison indicates that the input code matches the reference password.

Compared with the prior art, the present invention provides an electric lock control circuit and method whereby the clockwise or anticlockwise rotation of the input unit (such as a tracking ball or a dial) in a multidimensional space indirectly produces parameters (such as angles of rotation and angles of inclination) pertaining to rotation in a multidimensional space. Afterward, the parameters are converted into an input code pertaining to a parameter related to at least two dimensions. Then, the input code is compared with the reference password which is pre-stored, with a view to controlling the unlocking of the electric lock. The electric lock control circuit and method further allow the generation of the reference password pertaining to a parameter related to multiple dimensions, such that the generated reference password functions as a password for locking the electric lock. Hence, the present invention is effective in overcoming the aforesaid drawback of conventional mechanical dials of safes, that is, password theft.

### BRIEF DESCRIPTION

Objectives, features, and advantages of the present invention are hereunder illustrated with specific embodiments in conjunction with the accompanying drawings, in which:

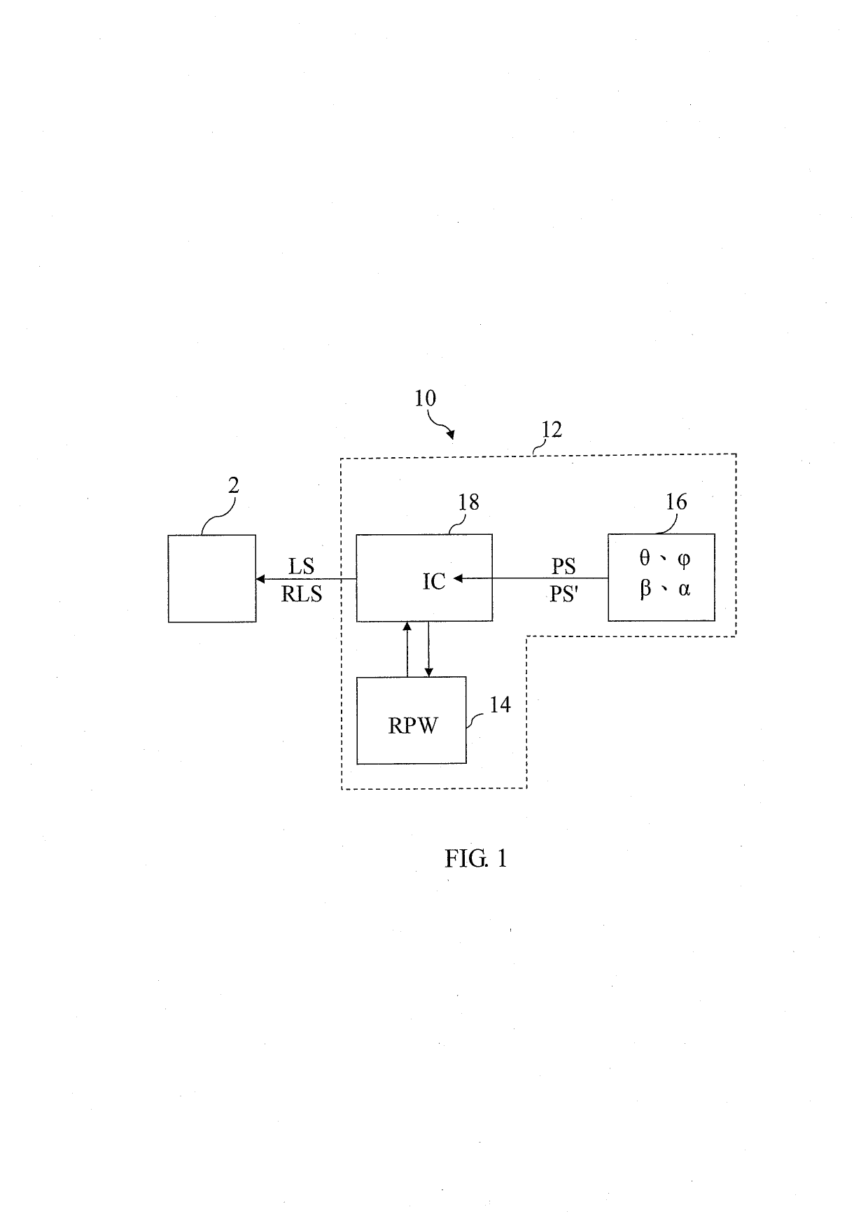

FIG. 1 is a schematic view of an electric lock control circuit according to the first embodiment of the present invention;

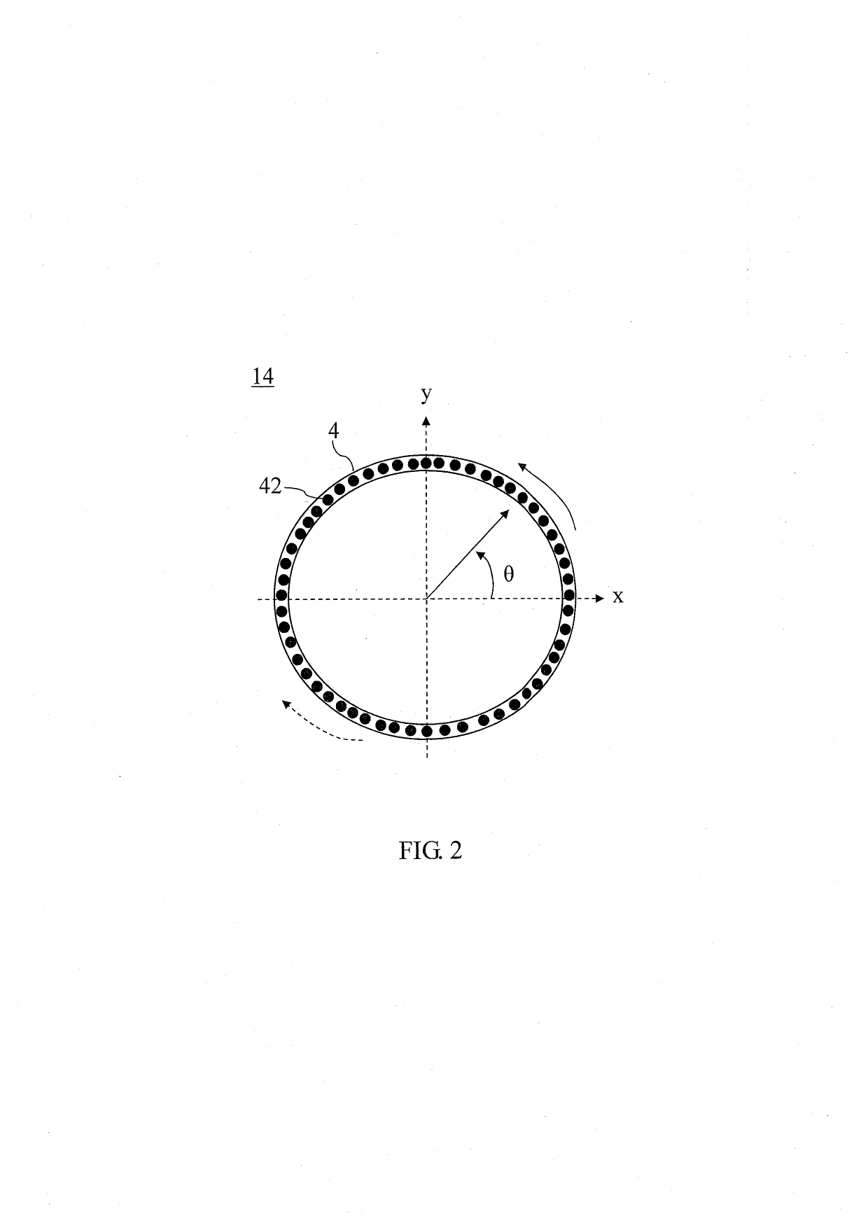

FIG. 2 is a schematic view of operation of an input unit (not shown) on a two-dimensional plane;

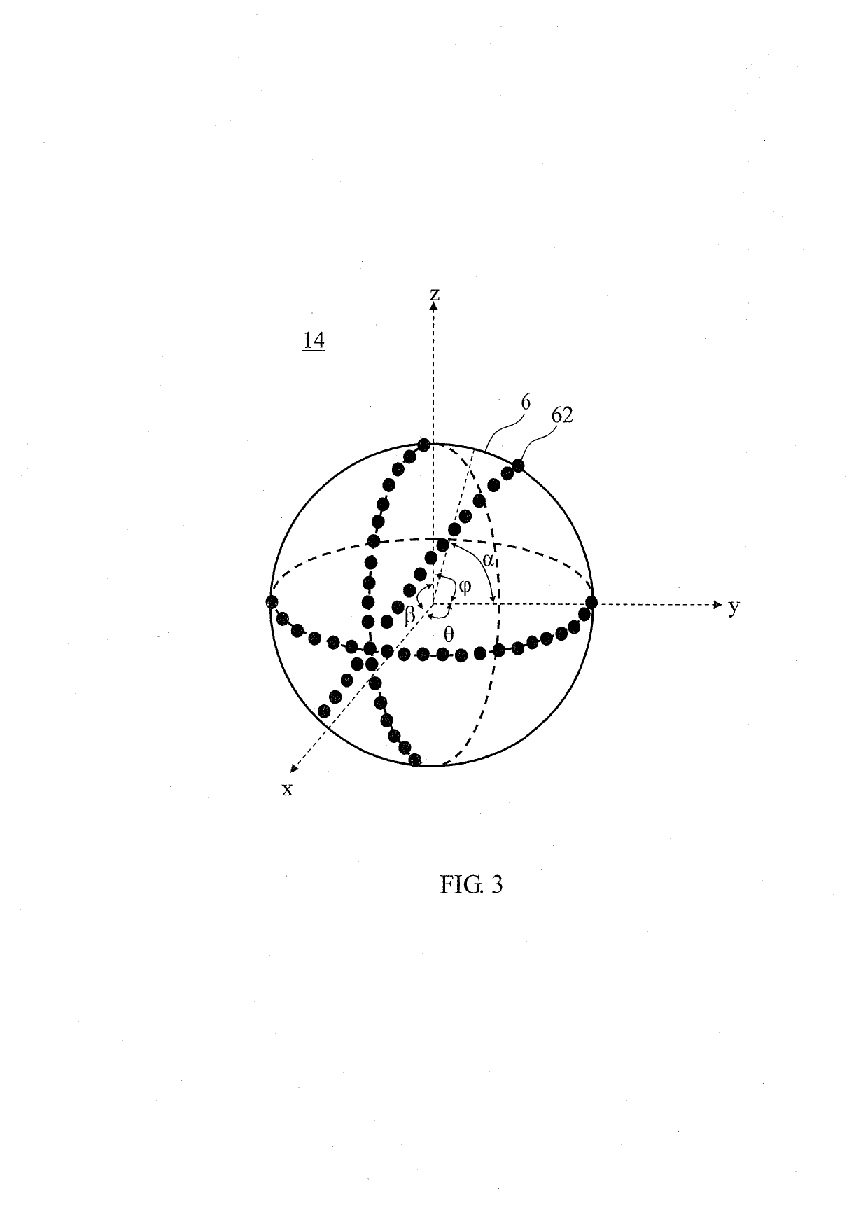

FIG. 3 is a schematic view of operation of the input unit (not shown) in a three-dimensional space;

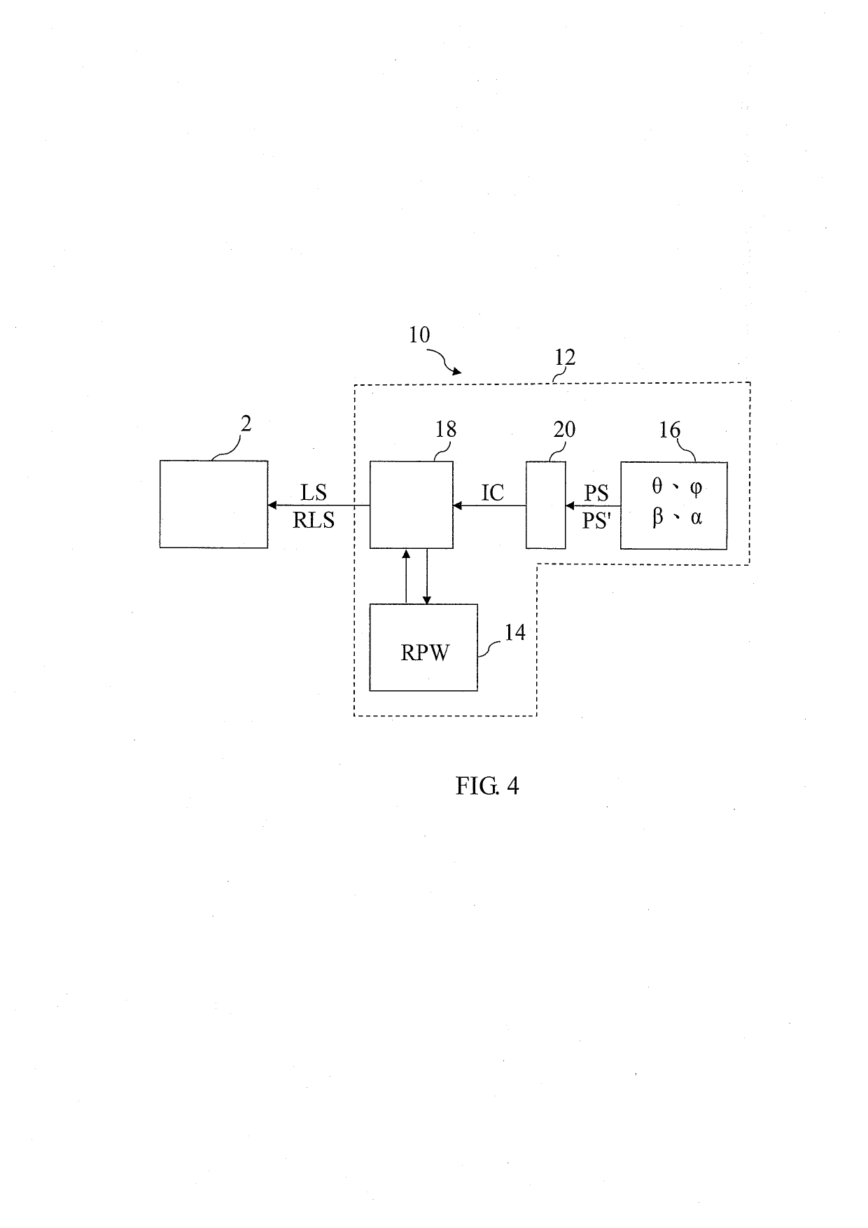

FIG. 4 is a schematic view of the electric lock control circuit according to the second embodiment of the present invention;

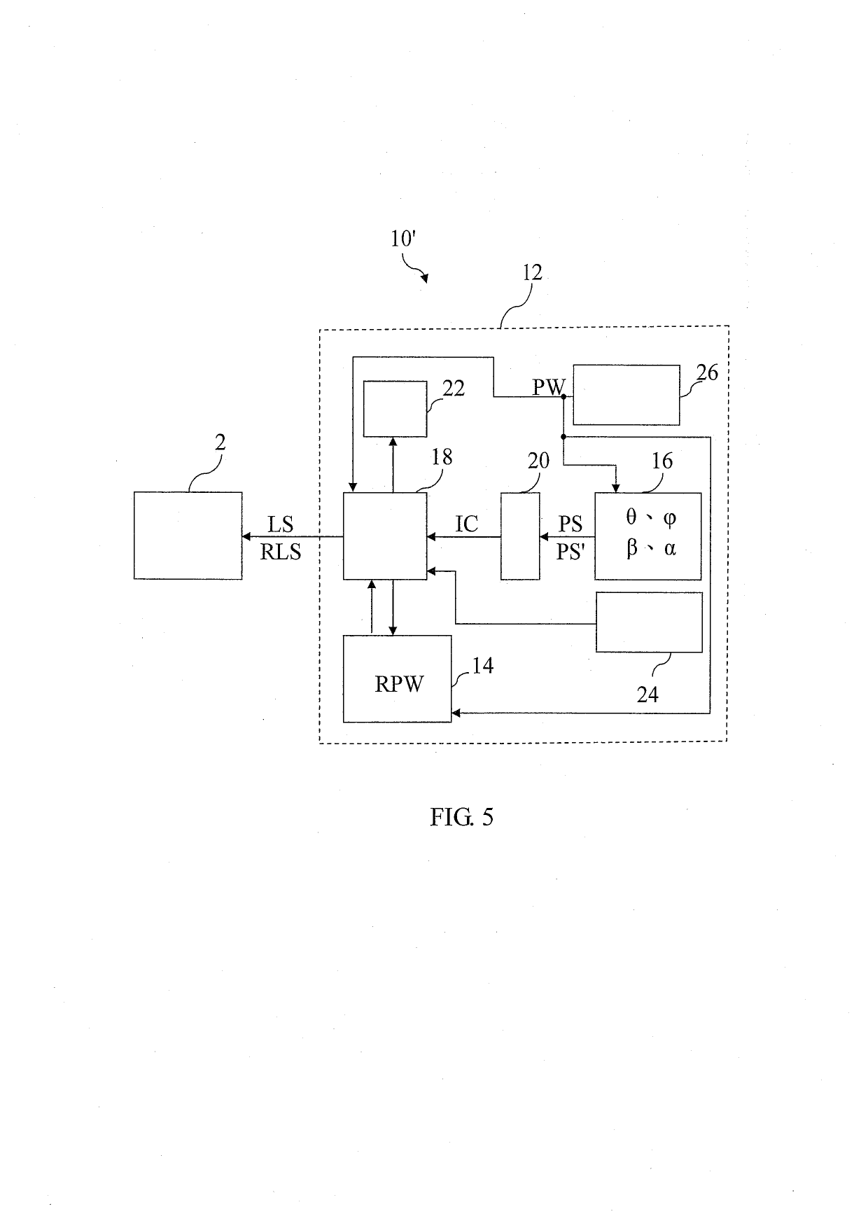

FIG. 5 is a schematic view of the electric lock control circuit according to the third embodiment of the present invention;

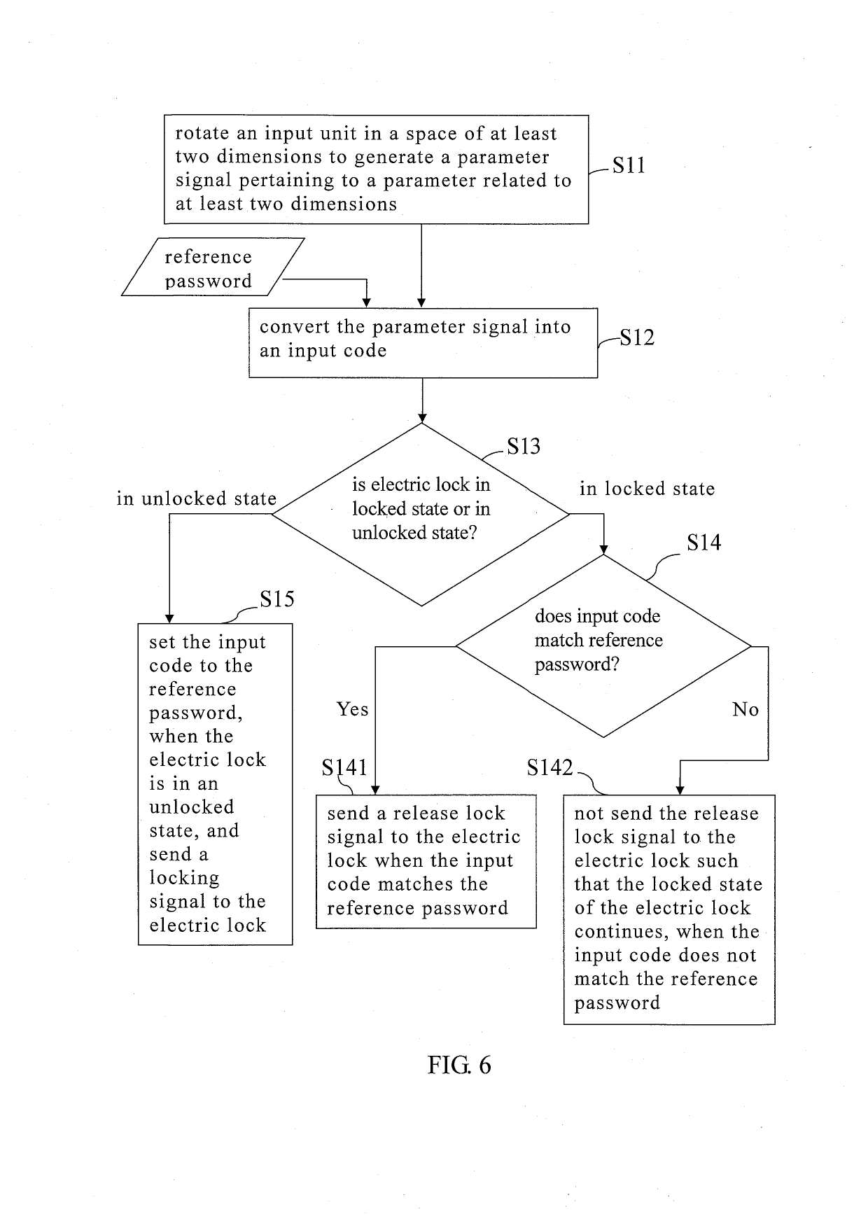

FIG. 6 is a flow chart of an electric lock control method according to the first embodiment of the present invention; and

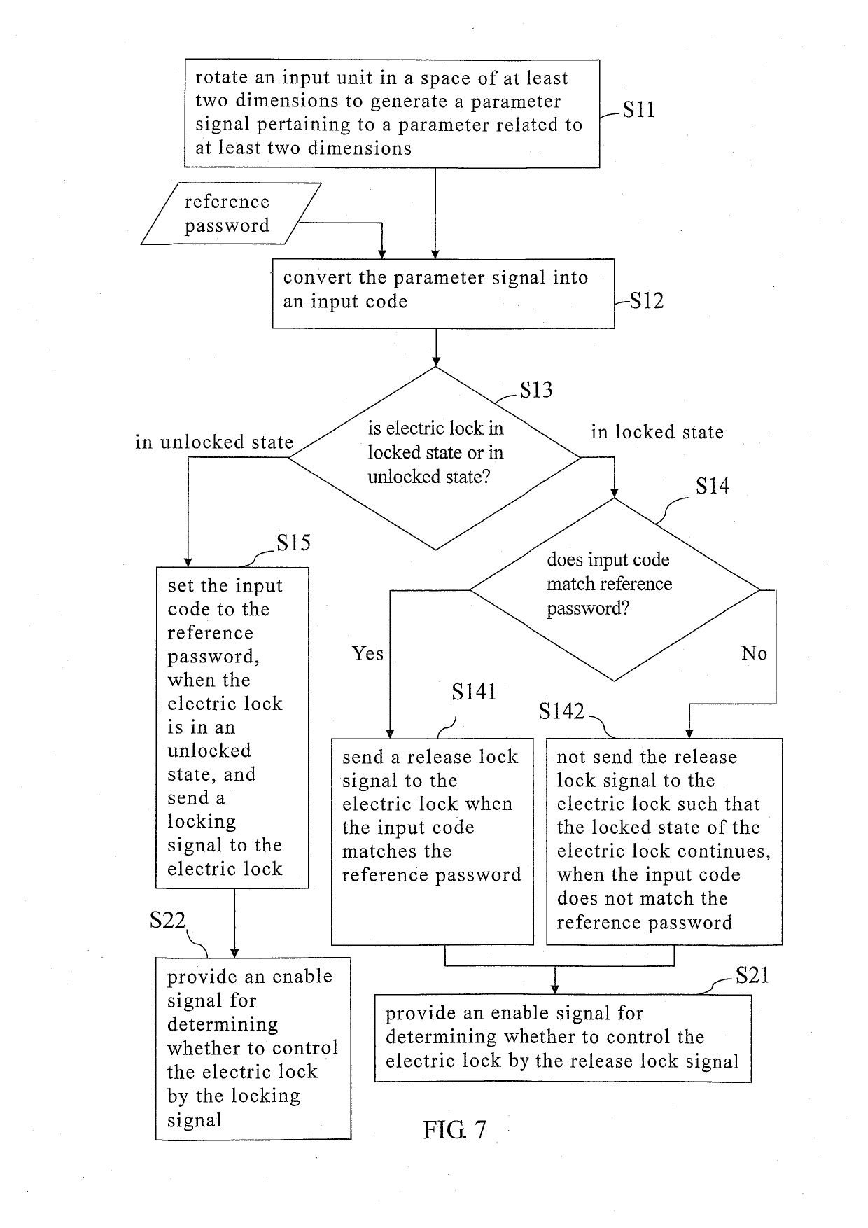

FIG. 7 is a flow chart of the electric lock control method according to the second embodiment of the present invention.

### DETAILED DESCRIPTION

Referring to FIG. 1, there is shown a schematic view of an electric lock control circuit 10 according to the first embodiment of the present invention. As shown in FIG. 1, the electric lock control circuit 10 provides a user with a reference password RPW pertaining to a parameter related to at least two dimensions, and the reference password RPW determines whether an electric lock 2 has to enter a locked state or an unlocked state. For example, the electric lock 2 is a magnetically-controlled electric lock, an electrically-controlled electric lock, or an electric lock which is locked and unlocked by an electrical signal, a magnetic signal, or any other appropriate signal. Furthermore, before the user starts to manipulate the electric lock 2, the reference password RPW is set by the electric lock control circuit of the present invention.

The electric lock control circuit 10 comprises a substrate 12, a memory unit 14, an input unit 16, and a processing unit 18.

The memory unit 14 is disposed on the substrate 12 for storing the reference password RPW. For example, the memory unit 14 is a cache memory (cache memory), a flash memory, a read-only memory, or a volatile memory. The memory unit 14 that comes in the form of a flash memory, a read-only memory, or a volatile memory is self-contained. By contrast, the memory unit 14 that comes in the form of a cache memory is built in the processing unit 18. The memory unit 14 described hereunder is exemplified by a flash memory.

In an embodiment, the input unit 16 generates a password and sends the password to the processing unit 18. Then, the processing unit 18 determines whether the electric lock 2 is in the unlocked state. Upon determination that the electric lock 2 is in the unlocked state, the processing unit 18 converts the password into the reference password RPW. Then, the reference password RPW is sent to the memory unit 14 and stored therein. Afterward, the processing unit 18 generates a locking signal LS according to the reference password RPW and sends the locking signal LS to the electric lock 2 to instruct the electric lock 2 to enter the locked state.

The input unit 16 is disposed on the substrate 12. The input unit 16 generates a parameter signal PS according to the rotation of the input unit 16 in a space of at least two dimensions (for example, in a two-dimensional coordinate system, a three-dimensional coordinate system, or a multi-dimensional coordinate system). For example, the parameter signal PS expresses angles α, β, θ and φ of the rotation of the input unit 16 in the space of at least two dimensions, as shown in FIG. 2 and FIG. 3. Due to the rotation of the input unit 16 in the space of at least two dimensions, variation of the angles α, β, θ and φ triggers the generation of the parameter signal PS or the generation of a parameter signal PS′. In this regard, the angles α, β, θ and φ each refer to an angle of rotation of the input unit 16 and/or an angle of inclination of the input unit 16. The angles of inclination of the input unit 16 are defined as the included angles between a vector of angular displacement of the input unit 16 in a three-dimensional coordinate system and the components of the projection of the vector on the x-y plane, y-z plane, and x-z plane, respectively. For example, in a three-dimensional coordinate system, the input unit 16 manifests inclination angles θ, φ, and β, where θ denotes the included angle between the vector and its component on the x-y plane, φ denotes the included angle between the vector and its component on the y-z plane, and β denotes the included angle between the vector and its component on the x-z plane.

Referring to FIG. 1, the processing unit 18 is connected between the memory unit 14 and the input unit 16. The processing unit 18 converts the parameter signal RPW into the input code IC. The processing unit 18 determines, by comparing the reference password RPW and the input code IC, whether to generate and send a release lock signal RLS to the electric lock 2 to instruct the electric lock 2 to remain locked or to unlock. For example, if the input code IC matches the reference password RPW, the processing unit 18 will generate and send the release lock signal RLS to instruct the electric lock 2 to unlock. Conversely, if the input code IC does not match the reference password RPW, the processing unit 18 will instruct the electric lock 2 to keep its locked state.

The processing unit 18 is equipped with a confirmation button (not shown) for confirming that the parameter signals PS, PS′ generated from the input unit 16 have been received by the processing unit 18. Alternatively, the processing unit 18 dispenses with the confirmation button but is capable of sampling automatically the parameter signal PS generated from the input unit 16 at a preset time interval, such as several seconds.

In addition to confirming that the parameter signals PS, PS′ generated from the input unit 16 have been received by the processing unit 18, the confirmation button is capable of confirming that the parameter signals PS received by the processing unit 18 has been sent to the memory unit 14 and stored therein to function as the reference password RPW. As regards timing, generation of the parameter signal PS by the input unit 16 is automatically followed by storing the generated parameter signal PS in the memory unit 14 after a specific period of time has passed.

Referring to FIG. 2, in a two-dimensional coordinate system (also known as Cartesian coordinate system), the input unit 16 is a gravity sensor, a gyroscope, or a combination thereof, lies on the x-y, and rotates by angle θ. The variation of the rotation angle θ triggers generation of the parameter signal PS. In an embodiment, the input unit 16 takes the form of a knob 4. To enable the user to fine-tune the knob 4 clockwise or anticlockwise, 360 graduations 42 are circumferentially disposed at the brim of the knob 4 and equally spaced apart from each other, such that every said graduation 42 represents 1°. In another embodiment not shown, the 360 graduations 42 circumferentially disposed at the brim of the knob 4 are not equally spaced apart from each other.

Referring to FIG. 3, in a three-dimensional coordinate system, the input unit 14 is the gyroscope and rotates on the x-y plane by the angle θ, on the y-z plane by the angle φ, on the z-x plane by the angle β, or in x-y-z three-dimensional space by the angle α. In an embodiment, the input unit 14 takes the form of a ball knob 6. Again, 360 graduations 62 equally spaced apart from each other are disposed at the circumference of the x-y plane, the circumference of the y-z plane, and the circumference of the z-x plane to enable the user to fine-tune the rotation of the input unit 14 in any direction.

Referring to FIG. 4, there is shown a schematic view of the electric lock control circuit 10 according to the second embodiment of the present invention. As shown in FIG. 4, the electric lock control circuit 10 further comprises an analog-to-digital conversion unit 20 for converting the analog parameter signal PS, PS′ into a digital input code IC related to at least two dimensions and then sending the input code IC to the processing unit 18.

In a variant embodiment (not shown) derived from the second embodiment of the present invention, the processing unit 18 is not equipped with an analog-to-digital conversion unit but is capable of converting the analog parameter signal PS, PS′ into the digital input code IC related to at least two dimensions.

Referring to FIG. 5, there is shown a schematic view of an electric lock control circuit 10′ according to the third embodiment of the present invention. As shown in FIG. 5, in addition to the substrate 12, the memory unit 14, the input unit 16, and the processing unit 18, the electric lock control circuit 10′ comprises a display unit 22, a confirmation unit 24, and a power supply unit 26.

The display unit 22 is connected to the processing unit 18 and adapted to display the input code IC, such that the user rotating the input unit 16 can know the degree of rotation not only by reading the graduations but also by watching the display unit 22 that shows the input code IC or the parameter signal PS, PS′ denoting the angles α, β, θ and φ. In another embodiment, the display unit 22 further indicates the locked state and the unlocked state of the electric lock 2.

The confirmation unit 24 is connected to the processing unit 18 and adapted to confirm having received the parameter signals PS, PS′ or confirm having determined to instruct the electric lock 2 to lock or unlock.

The power supply unit 26 is connected to the memory unit 14, the input unit 16, and the processing unit 18 and adapted to supply power PW to the electric lock control circuit 10′. For example, the power supply unit 26 is an external power source (such as grid power, or a solar cell) or is a built-in power source (such as a primary battery or a secondary battery.)

Referring to FIG. 6, there is shown a flow chart of an electric lock control method according to the first embodiment of the present invention. As shown in FIG. 6, the electric lock control method enables the user to control the locking and unlocking of the electric lock 2, wherein the electric lock 2 is controlled with the reference password RPW pertaining to a parameter related to at least two dimensions.

The process flow of the electric lock control method starts from step S11 that involves rotating the input unit 12 in a space of at least two dimensions to generate the parameter signal pertaining to a parameter related to at least two dimensions.

Step S12 involves converting the parameter signal into the input code.

Step S13 involves determining whether the electric lock is in the locked state or the unlocked state by the processing unit 18 and then going to step S14 or step S15 as appropriate.

Step S14 involves comparing the input code with the reference password when the electric lock is in the locked state and determining that the release lock signal RLS has to be sent to the electric lock when a result of the comparison indicates that the input code matches the reference password. Depending on the result of the comparison performed in step S14, step S14 is followed by step S141 or step S142. If the result of the comparison indicates that the input code IC matches the reference password RPW, step S14 will be followed by step S141. Step S141 involves sending the release lock signal RLS to the electric lock to instruct the electric lock to unlock and enter the unlocked state. Conversely, if the result of the comparison indicates that the input code IC does not match the reference password RPW, step S14 will be followed by step S142. Step S142 involves not sending the release lock signal RLS to the electric lock, such that the locked state of the electric lock 2 continues.

Step S15 involves setting the input code IC to the reference password when the electric lock is in the unlocked state, and sending a locking signal LS to the electric lock to cause the electric lock to enter the locked state.

Referring to FIG. 7, there is shown a flow chart of the electric lock control method according to the second embodiment of the present invention. As shown in FIG. 7, in addition to steps S11˜S15, the electric lock control method comprises step S21 that follows step S141 and S142. Step S21 involves providing an enable signal for determining whether to control the electric lock by means of the release lock signal RLS. That is to say, the release lock signal RLS is output in step S14, and then step S21 determines whether to control the electric lock with the release lock signal RLS. Step S15 is followed by step S22 that involves providing an enable signal for determining whether to control the electric lock by means of the locking signal LS. The enable signal is generated by the confirmation unit 24.

The electric lock control method further comprises the step of showing the user the input code, the angles, or the status of the electric lock.

Accordingly, the present invention provides an electric lock control circuit and method whereby the clockwise or anticlockwise rotation of the input unit (such as a tracking ball or a dial) in a multidimensional space indirectly produces parameters (such as angles of rotation and angles of inclination) pertaining to rotation in a multidimensional space. Afterward, the parameters are converted into an input code pertaining to a parameter related to at least two dimensions. Then, the input code is compared with the reference password which is pre-stored, with a view to controlling the unlocking of the electric lock. The electric lock control circuit and method further allow the generation of the reference password pertaining to a parameter related to multiple dimensions, such that the generated reference password functions as a password for locking the electric lock. Hence, the present invention is effective in overcoming the aforesaid drawback of conventional mechanical dials of safes, that is, password theft.

The foregoing embodiments are provided to illustrate and disclose the technical features of the present invention so as to enable persons skilled in the art to understand the disclosure of the present invention and implement the present invention accordingly, and are not intended to be restrictive of the scope of the present invention. Hence, all equivalent modifications and replacements made to the foregoing embodiments without departing from the spirit embodied in the disclosure of the present invention should fall within the scope of the present invention as set forth in the appended claims. Accordingly, the legal protection for the present invention should be defined by the appended claims.

What is claimed is:

1. An electric lock control circuit for controlling an electric lock with a reference password pertaining to a parameter related to at least two dimensions, the electric lock control circuit comprising:
a substrate;
a memory unit disposed on the substrate for storing the reference password;
an input unit disposed on the substrate for generating a parameter signal based on rotation of the input unit in a space of at least two dimensions; and
a processing unit connected to the memory unit and the input unit for converting the parameter signal into an input code and sending a release lock signal to the electric lock when the input code matches the reference password.

2. The electric lock control circuit of claim 1, wherein the processing unit sets the input code to the reference password when the electric lock is in an unlocked state and then sends a locking signal to the electric lock.

3. The electric lock control circuit of claim 1, further comprising a display unit connected to the processing unit for displaying the input code, the parameter signal, and a locked state of the electric lock.

4. The electric lock control circuit of claim 1, further comprising a confirmation unit connected to the processing unit for determining sending the parameter signal to the processing unit when the electric lock is in an unlocked state.

5. The electric lock control circuit of claim 1, wherein the processing unit samples at a preset time interval the input code generated from the input unit.

6. The electric lock control circuit of claim 1, further comprising a power supply unit connected to the memory unit, the input unit, and the processing unit for supplying power to the memory unit, the input unit, and the processing unit.

7. The electric lock control circuit of claim 1, wherein the input unit is one of a gravity sensor, a gyroscope, and a combination thereof.

8. The electric lock control circuit of claim 1, wherein the input unit has graduations corresponding or not corresponding to the parameter signal, and the parameter signal denotes at least one of an angle of rotation and an angle of inclination.

9. The electric lock control circuit of claim 1, further comprising an analog-to-digital conversion unit connected to the processing unit and the input unit for converting the parameter signal in an analog format into the parameter signal in a digital format.

10. An electric lock control method for controlling an electric lock having an input unit, the electric lock being controlled with a reference password pertaining to a parameter related to at least two dimensions, the electric lock control method comprising the steps of:
step (a): rotating the input unit in a space of at least two dimensions to generate a parameter signal pertaining to a parameter related to at least two dimensions;
step (b): converting the parameter signal into an input code; and
step (c): comparing the input code with the reference password when the electric lock is in a locked state to determine that a release lock signal has to be sent to the electric lock when a result of the comparison indicates that the input code matches the reference password.

11. The electric lock control method of claim 10, further comprising step (d) after step (c), the step (c) providing an enable signal for determining whether to control the electric lock by the release lock signal.

12. The electric lock control method of claim 10, further comprising step (e) after step (b), the step (e) setting the input code to the reference password when the electric lock is in an unlocked state, and sending a locking signal to the electric lock to cause the electric lock to enter the locked state.

13. The electric lock control method of claim 12, further comprising step (f) after step (e), the step (f) providing an enable signal for determining whether to control the electric lock by the locking signal.
